(19) United States
(12) Patent Application Publication
(10) Pub. No.: US 2022/0012443 A1
(43) Pub. Date: Jan. 13, 2022

(54) COMMUNICATION APPARATUS FOR PERFORMING COMMUNICATION WITH TAG BY USING MATRIX LAYER

(71) Applicant: WHOBORN INC., Seoul (KR)

(72) Inventor: Young Sik BAE, Seoul (KR)

(21) Appl. No.: 17/294,830

(22) PCT Filed: Nov. 19, 2019
(86) PCT No.: PCT/KR2019/015821

§ 371 Date: May 18, 2021

(30) Foreign Application Priority Data
Nov. 20, 2018 (KR) 10-2018-0143462
Oct. 18, 2019 (KR) 10-2019-0129906
Nov. 18, 2019 (KR) 10-2019-0147809

(51) Int. Cl. G06K 7/10; G06K 19/07

(52) U.S. Cl. CPC G06K 7/10475; G06K 19/0723; G06K 7/10297

(57) ABSTRACT

Disclosed is a communication apparatus for performing communication with a tag using a matrix layer. A communication apparatus according to an embodiment includes a substrate including a plurality of layers, and a plurality of readers or a plurality of wireless communication antennas that detect a tag and are arranged on at least one of an upper surface and a lower surface of each of the plurality of layers.

### RELATED APPLICATION

This application claims benefit of priority to Korean Patent Application Serial Number 1020180143462, filed on Nov. 20, 2018, Korean Patent Application Serial Number 1020190129906, filed on Oct. 18, 2019, Korean Patent Application Serial Number 1020190147809 filed on Nov. 18, 2019, and PCT Application PCT/KR2019/015821, filed on Nov. 19, 2019 titled: COMMUNICATION APPARATUS FOR PERFORMING COMMUNICATION WITH TAG BY USING MATRIX LAYER, which are all incorporated herein by reference in their entirety for all purposes.

Unless otherwise indicated herein, the approaches described in this section are not prior art to the claims in this application and are not admitted to be prior art by inclusion in this section.

In recent years, short-range wireless communication is attracting attention as a technology to replace barcodes that have been widely used in the related art. For example, short-range wireless communication can process more information than barcodes.

In recent years, it is possible to transmit and receive information on a thing, such as an object being targeted, using short-range wireless communication. For example, in short-range wireless communication, information may be transmitted or received without direct contact or scanning.

Short-range wireless communication may be configured with a reader and a tag. For example, the reader may receive information on the tag by reading the tag attached to an object or the like. The tag may store information about a thing and transmit the stored information to the reader.

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative communication apparatus and system for performing communication with a tag using a matrix layer. Example communication apparatus may include a substrate including a number of layers. Additionally, example communication apparatus may include a number of readers or a number of wireless communication antennas that detect a tag and are arranged on at least one of an upper surface and a lower surface of each of the number of layers.

Example communication system may include a tag, and a communication apparatus that recognizes information of the tag. The communication apparatus included in the example communication system may include a substrate including a number of layers and a number of readers or a number of wireless communication antennas that detects the tag and are arranged on at least one of an upper surface and a lower surface of each of the number of layers.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a schematic block diagram of a communication system according to an embodiment;

FIG. 2 illustrates a schematic block diagram of the communication apparatus illustrated in FIG. 1;

FIG. 3 illustrates an example for describing an arrangement of readers and/or antennas arranged on a substrate according to an embodiment;

FIG. 4A illustrates an example for describing readers and/or antennas arranged on a first layer of the substrate illustrated in FIG. 3;

FIG. 4B illustrates an example for describing readers and/or antennas arranged on a second layer of the substrate illustrated in FIG. 3;

FIG. 4C illustrates an example for describing readers and/or antennas arranged on a third layer of the substrate illustrated in FIG. 3;

FIG. 5 illustrates an example for describing an overlapping arrangement of readers and/or antennas according to an embodiment;

FIG. 6A illustrates another example for describing the overlapping arrangement of the readers and/or antennas according to the embodiment;

FIG. 6B illustrates an example for describing readers and/or antennas arranged on a first layer of FIG. 6A;

FIG. 6C illustrates an example for describing readers and/or antennas arranged on a second layer of FIG. 6A;

FIG. 6D illustrates an example for describing readers and/or antennas arranged on a third layer of FIG. 6A;

FIG. 6E illustrates an example for describing readers and/or antennas arranged on a fourth layer of FIG. 6A;

FIG. 7A illustrates still another example for describing the overlapping arrangement of the readers and/or antennas according to the embodiment;

FIG. 7B illustrates an example for describing readers and/or antennas arranged on a first layer of FIG. 7A;

FIG. 7C illustrates an example for describing readers and/or antennas arranged on a second layer of FIG. 7A;

FIG. 7D illustrates an example for describing readers and/or antennas arranged on a third layer of FIG. 7A;

FIG. 7E illustrates an example for describing readers and/or antennas arranged on a fourth layer of FIG. 7A;

FIG. 8A illustrates still yet another example for describing the overlapping arrangement of the readers and/or antennas according to the embodiment;

FIG. 8B illustrates an example for describing readers and/or antennas arranged on a first layer of FIG. 8A;

FIG. 8C illustrates an example for describing readers and/or antennas arranged on a second layer of FIG. 8A;

FIG. 8D illustrates an example for describing readers and/or antennas arranged on a third layer of FIG. 8A;

FIG. 8E illustrates an example for describing readers and/or antennas arranged on a fourth layer of FIG. 8A; and

FIG. 9 is a flowchart for illustrating an operation of a controller illustrated in FIG. 2.

### DETAILED DESCRIPTION

Hereinafter, embodiments will be described in detail with reference to the accompanying drawings. However, since various changes may be made to the embodiments, the scope of rights of the patent application is not limited or restricted by these embodiments. It should be understood that all changes, equivalents, or substitutes to the embodiments are included in the scope of the rights.

The terms used in the embodiments are used for illustrative purposes only and should not be interpreted as limiting. A singular expression includes a plural expression unless it is explicitly meant differently in the context. In the present specification, it is to be understood that terms such as “include” or “have” are intended to designate the existence of features, numbers, steps, actions, components, parts, or combinations thereof described in the specification and do not preclude the possibility of the presence or addition of one or more other features or numbers, steps, actions, components, parts, or combinations thereof.

Terms such as first and second may be used to describe various components, but the components should not be limited by the terms. Terms are used only for the purpose of distinguishing one component from another component. For example, a first component may be named as a second component without departing from the scope of rights according to the concept of the embodiment, and similarly, the second component may also be named as the first component.

Unless otherwise defined, all terms used herein including technical or scientific terms have the same meaning as generally understood by a person of ordinary skill in the art to which the present invention pertains. Terms such as those defined in a generally used dictionary, should be interpreted as having a meaning consistent with the meaning in the context of the related technology, and are not to be interpreted as an ideal or excessively formal meaning unless explicitly defined in the present application.

In addition, in describing the embodiments with reference to the accompanying drawings, the same reference numerals are assigned to the same components regardless of the drawing numerals, and redundant descriptions thereof will be omitted. In describing the embodiments, when it is determined that a detailed description of related known technologies may unnecessarily obscure the essential part of the embodiments, a detailed description thereof will be omitted.

A module in the present specification may mean hardware capable of performing functions and operations according to each name described in the present specification, may mean a computer program code capable of causing a specific function and operation to be performed, or may mean an electronic recording medium, for example, a processor or a microprocessor in which the computer program code capable of causing the specific function and operation to be performed is installed.

In other words, the module may mean a functional and/or structural combination of hardware for implementing the technical idea of the present invention and/or software for driving the hardware.

Hereinafter, embodiments will be described in detail with reference to the accompanying drawings. However, the scope of the patent application is not limited or restricted by these embodiments. The same reference numerals illustrated in each drawing indicate the same members.

This disclosure is drawn, inter alia, to a communication apparatus for performing communication with a tag using a matrix layer. Embodiments may provide a technology for recognizing tag information by activating a plurality of readers grouped and arranged on a substrate composed of a plurality of layers for each layer and for each group.

A communication apparatus according to an embodiment includes a substrate including a plurality of layers, and a plurality of readers or a plurality of wireless communication antennas that detect a tag and are arranged on at least one of an upper surface and a lower surface of each of the plurality of layers.

The plurality of readers or the plurality of wireless communication antennas arranged on each of the plurality of layers may be arranged by being grouped into a plurality of groups.

The plurality of readers or the plurality of wireless communication antennas arranged on each of the plurality of layers may be grouped based on an arrangement order of readers or a plurality of wireless communication antennas arranged on each layer.

The plurality of readers or the plurality of wireless communication antennas arranged on each of the plurality of layers may be arranged based on positions of readers or a plurality of wireless communication antennas arranged on adjacent layers.

The plurality of readers or the plurality of wireless communication antennas arranged on each of the plurality of layers may be arranged so as not to overlap or overlap the positions of the readers or the plurality of wireless communication antennas arranged on the adjacent layer.

The plurality of readers or the plurality of wireless communication antennas may be arranged so that reading regions for detecting the tag are overlapped or not overlapped with each other.

The communication apparatus may further include a controller that recognizes tag information by controlling readers or a plurality of wireless communication antennas grouped into any one of the plurality of groups.

The controller may control activation of the readers or the plurality of wireless communication antennas grouped into any one of the groups.

The controller may control all of the plurality of readers or the plurality of wireless communication antennas to be switched for each group by activating the readers or the plurality of wireless communication antennas grouped into any one of the groups.

A communication system according to an embodiment includes a tag and a communication apparatus that recognizes information of the tag, and the communication apparatus includes a substrate including a plurality of layers and a plurality of readers or a plurality of wireless communication antennas that detects the tag and are arranged on at least one of an upper surface and a lower surface of each of the plurality of layers.

The plurality of readers or the plurality of wireless communication antennas arranged on each of the plurality of layers may be arranged by being grouped into a plurality of groups.

The plurality of readers or the plurality of wireless communication antennas arranged on each of the plurality of layers may be arranged by being grouped into a plurality of groups.

The plurality of readers or the plurality of wireless communication antennas arranged on each of the plurality of layers may be arranged based on positions of readers or a plurality of wireless communication antennas arranged on adjacent layers.

The plurality of readers or the plurality of wireless communication antennas arranged on each of the plurality of layers may be arranged so as not to overlap or overlap the positions of the readers or the plurality of wireless communication antennas arranged on the adjacent layer.

The plurality of readers or the plurality of wireless communication antennas may be arranged so that reading regions for detecting the tag are overlapped or not overlapped with each other.

The communication device may further include a controller that recognizes tag information by controlling readers or a plurality of wireless communication antennas grouped into any one of the plurality of groups.

The controller may control activation of the readers or the plurality of wireless communication antennas grouped into any one of the groups.

The controller may control all of the plurality of readers or the plurality of wireless communication antennas to be switched for each group by activating the readers or the plurality of wireless communication antennas grouped into any one of the groups.

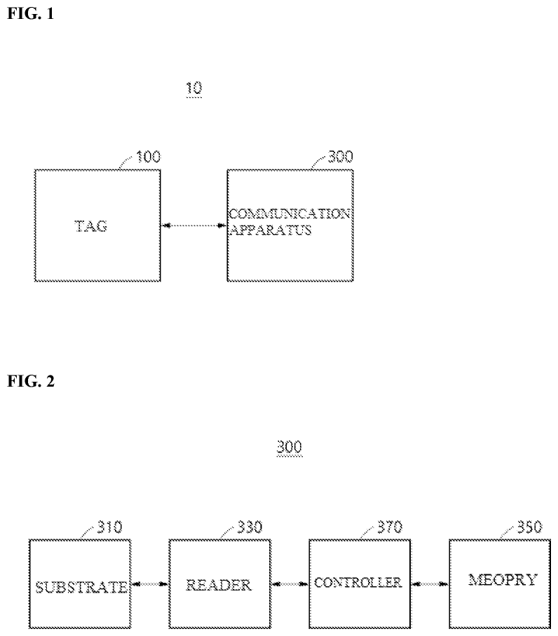

FIG. 1 is a schematic block diagram of a communication system according to an embodiment.

The communication system 10 includes a tag 100 and a communication apparatus 300.

The object may be a variety of objects to which a tag may be attached, such as a thing, a person, or an animal.

The tag 100 may store object information and transmit (or transmit/receive) the stored object information to the communication apparatus 300.

For example, the tag 100 stores object information through a tag chip included in the tag 100 and transmits the object information to the communication apparatus 300 through an antenna included in the tag 100. The antenna may have a wireless frequency (RF) characteristic capable of transmitting and receiving a frequency corresponding to a signal transmitted and received to and from the communication apparatus 300.

The communication apparatus 300 may recognize information of the tag 100 by activating a plurality of readers arranged by being grouped on a substrate composed of a plurality of layers for each layer and for each group. The information of the tag 100 may be position information of the tag 100 and information stored by the tag 100.

When the communication apparatus 300 is manufactured as a board game board, the communication apparatus 300 may activate a plurality of readers for each layer and each group to accurately read the position information of the tag 100 manufactured as a horse in a board game. For example, the communication apparatus 300 may accurately read an actual position of the tag 100 through readers physically increased for each layer and densely arranged for each group.

Accordingly, the communication apparatus 300 may minimize or eliminate interference by reducing interference between adjacent readers through readers distinguished for each layer and each group, and accurately read the information of the tag 100 in real time by detecting the exact position of the reader that the tag 100 contacts.

The communication apparatus 300 may provide accurate information on the tag 100 possessed by the tag 100 according to the classification of the wireless communication tag in the form of multiple identification through the readers activated for each layer and each group.

The communication apparatus 300 may be used for various object identification and communication in which the tag 100 is used, such as the horse with a tag of a board game, person-specific identification on the floor of a building, warehouse, precise measurement, and crop history management.

FIG. 2 illustrates a schematic block diagram of the communication apparatus illustrated in FIG. 1.

The communication apparatus 300 includes a substrate 310, a reader 330, a memory 350, and a controller 370.

The substrate 310 may be a single chipset composed of a rigid substrate or a soft substrate. The soft substrate may be a flexible substrate.

The substrate 310 may include a plurality of layers (or a plurality of layers) in a matrix form. For example, the substrate 310 may include a plurality of sub-substrates formed on each of the plurality of layers (or may be composed of a plurality of sub-substrates). The reader 310 may be arranged on the plurality of layers.

The reader 330 may be a wireless communication-based reader, such as wireless frequency identification (RFID) and near field communication (NFC). For example, the NFC reader is arranged in an antenna pattern, and may be driven by being connected to a reader chipset. The reader 330 may be a read/write reader.

The reader 330 may read and write the tag 100 through read and write functions of an RFID reader, an NFC reader, etc. and an antenna pattern connected to a reader module. The reader 330 may be implemented as various types of readers capable of communicating with the tag 100 through the antenna pattern.

For example, the reader 330 may read (or receive) the information of the tag 100 using RFID and NFC.

The reader 330 may include a plurality of readers arranged on the substrate 310. Each of the plurality of readers may be a read/write reader similar to the reader 330.

Each of the plurality of readers may read the tag 100 through an antenna corresponding to each of the plurality of readers. Each of the plurality of antennas may be arranged to correspond to the position of each of the plurality of readers.

Since the arrangement positions of the antenna and reader correspond to each other, the arrangement of the reader will be described below.

A plurality of readers may be arranged on an upper surface and/or a lower surface of each of the plurality of layers of the substrate 310.

The plurality of readers arranged on each of the plurality of layers may be arranged by being grouped into a plurality of groups.

For example, the plurality of readers arranged on each of the plurality of layers may be grouped into the plurality of groups based on an arrangement order of the readers arranged on each layer.

The plurality of readers arranged on each of the plurality of layers may be arranged based on positions of readers arranged on an adjacent layer among the plurality of layers.

For example, the plurality of readers arranged on each of the plurality of layers may be arranged so as not to overlap the positions of readers arranged on the adjacent layer among the plurality of layers. In this case, all of the plurality of readers arranged on the plurality of layers may be arranged so that the reading regions for detecting the tag 100 do not overlap each other.

The reader 330 may detect the tag 100 through any one of the plurality of readers.

For example, the reader 330 may detect the tag 100 through a reader matching the position of the tag 100 among the plurality of readers to read the information of the tag 100.

The memory 350 may store instructions (or programs) executable by the controller 370. For example, the instructions may include instructions for executing an operation of the controller 370 and/or an operation of each configuration of the controller 370.

The controller 370 may process data stored in the memory 350. The controller 370 may execute computer-readable code (e.g., software) stored in the memory 350 and instructions induced by the controller 370.

The controller 370 may be a data processing device implemented by hardware having a circuit having a physical structure for executing desired operations. For example, desired operations may include code or instructions included in a program.

For example, the data processing device implemented by hardware may include a microprocessor, a central processing unit, a processor core, a multi-core processor, a multiprocessor, an application-specific integrated circuit (ASIC), and a field programmable gate array (FPGA).

The controller 370 may control the overall operation of the communication apparatus 300. For example, the controller 370 may control the operation of each of the configurations 310 to 350 of the communication apparatus 300.

The controller 370 may recognize information of the tag 100 by controlling activation of a plurality of readers included in the reader 330.

The controller 370 may control activation of readers grouped into any one of a plurality of groups in which readers are grouped to recognize information of the tag 100 through the activated readers. In this case, the controller 370 may activate the readers grouped into any one of the plurality of groups so that all of the plurality of readers are switched for each group.

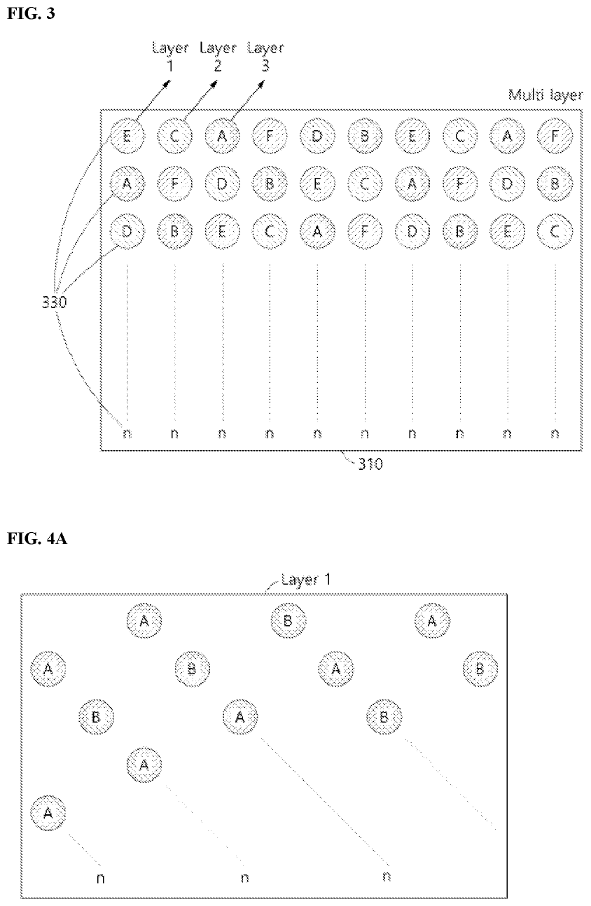

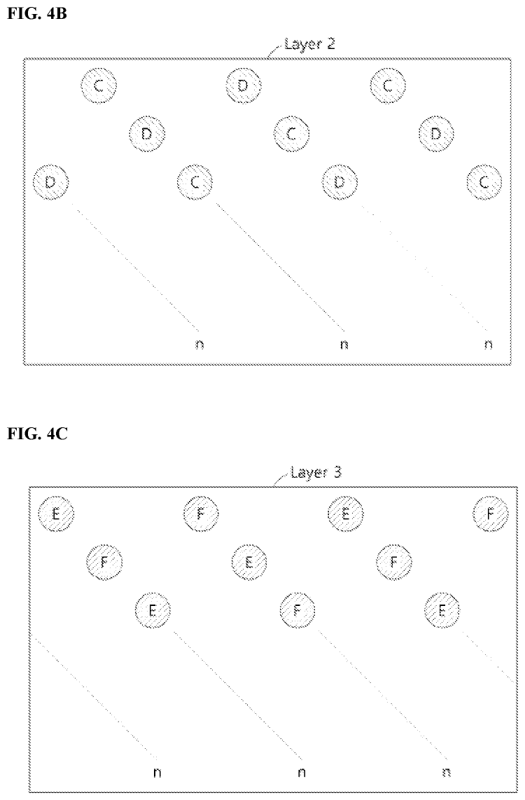

FIG. 3 illustrates an example for describing an arrangement of the readers and/or antennas arranged on a substrate according to an embodiment, FIG. 4A illustrates an example for describing readers and/or antennas arranged on a first layer of the substrate illustrated in FIG. 3, FIG. 4B illustrates an example for describing readers and/or antennas arranged on a second layer of the substrate illustrated in FIG. 3, and FIG. 4C illustrates an example for describing readers and/or antennas arranged on a third layer of the substrate illustrated in FIG. 3.

Alphabets A to E illustrated in FIGS. 3 to 4C are reader points, and may correspond to readers, antenna patterns, or readers+antenna patterns.

Referring to FIG. 3, the substrate 310 may include three layers. The substrate 310 may include a first sub-substrate, a second sub-substrate, and a third sub-substrate, which are sub-substrates formed on respective layers.

The first sub-substrate may be formed on a first layer (or layer 1). The first layer (layer 1) may be a lower layer positioned at the lower part of the substrate 310. The second sub-substrate may be formed on the second layer (or second layer; layer 2). The second layer (layer 2) may be a middle layer positioned in the middle of the substrate 310. The third sub-substrate may be formed on the third layer (or layer 3). The third layer (layer 3) may be an upper layer positioned on the upper part of the substrate 310.

The reader 330 may include a plurality of first readers, a plurality of second readers, and a plurality of third readers.

Referring to FIG. 4A, a plurality of first readers may be arranged on the first sub-substrate formed on the first layer (layer 1). The plurality of first readers may be grouped into Group A and Group B according to an arrangement order. Group A may be a group in which readers having an odd number of arrangement order are grouped. Group B may be a group in which readers having an even number of arrangement order are grouped.

Referring to FIG. 4B, a plurality of second readers may be arranged on the second sub-substrate formed on the second layer (layer 2). The plurality of second readers may be grouped into C group and D group according to the arrangement order. Group C may be a group in which readers having an odd number of arrangement order are grouped. Group D may be a group in which readers having an even number of arrangement order are grouped.

Referring to FIG. 4C, a plurality of third readers may be arranged on the third sub-substrate formed on the third layer (layer 3). The plurality of third readers may be grouped into Group E and Group F according to the arrangement order. Group E may be a group in which readers having an odd number of arrangement order are grouped. Group F may be a group in which readers having an even number of arrangement order are grouped.

Groups A to F may be respectively arranged on the sub-substrates so as not to overlap each other in the form of diagonal arrangement.

Readers grouped in Group A and readers grouped in Group B may be alternately arranged on diagonals. The readers grouped in Group A and the readers grouped in Group B may be spaced apart from each other as much as readers grouped in Group F and readers grouped in Group D and alternately arranged on straight lines.

Readers grouped in Group C and readers grouped in Group D may be alternately arranged on diagonal lines. The readers grouped in Group C and the readers grouped in Group D may be spaced apart from each other as much as the readers grouped in Group A and the readers grouped in Group F, and alternately arranged on straight lines.

Readers grouped in Group E and readers grouped in Group F may be alternately arranged on diagonal lines. The readers grouped in Group E and the readers grouped in Group F may be spaced apart from each other as much as the readers grouped in Group C and the readers grouped Group A, and alternately arranged on straight lines.

As described above, the substrate 310 includes three layers, but is not limited thereto. For example, the substrate 310 may include a various number of layers, such as two layers, four layers, and five layers. The groups of readers may gradually increase as the number of layers increases. The grouped plurality of readers may be designed to have a narrow gap between the grouped reader patterns in such a way of detecting an actual read position division of each of the grouped readers as a group recognition pattern. For example, a plurality of grouped readers may be arranged so that a recognized group is different by dividing the recognition points as ABC and BCE according to positions in the A, B, C, D, E, and F antenna patterns.

When the layers of the substrate 310 are made as multiple layers, the number of groups to which the readers are grouped increases by the number of layers, and thus the spacing between tag recognition regions of the plurality of readers may increase as the number of layers increases. The tag recognition region may be clearly distinguished as the number of layers increases. In addition, the spacing between the plurality of readers varies according to the size and arrangement of the reader according to the number of layers, and thus the spacing may become wider as the number of layers increases.

As the number of layers increases, the distance difference between readers increases, and thus interference between readers is minimized. Accordingly, the accuracy of tag recognition can be improved and increased as the number of layers increases. In addition, an error in transmitting information of the tag 100 may also be improved and reduced as the number of layers increases.

As described above, the reader 330 may be arranged for each layer and for each group and may be arranged so as not to overlap each other but is not limited thereto. For example, the reader 330 may be arranged for each layer and for each group and may be arranged to overlap each other. In this case, as described above, antennas arranged corresponding to the position of the reader 330 may also be arranged to overlap each other like the reader 300.

Hereinafter, the reader 330 arranged to overlap each other will be described in detail. For convenience of description, it is assumed that the substrate 310 is composed of four layers.

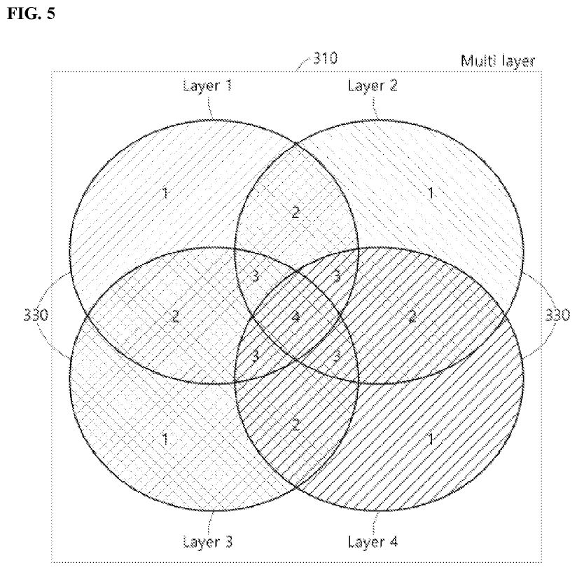

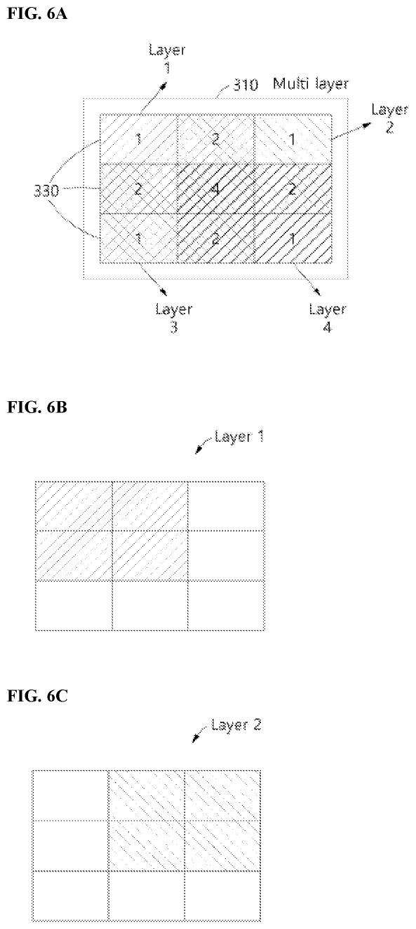

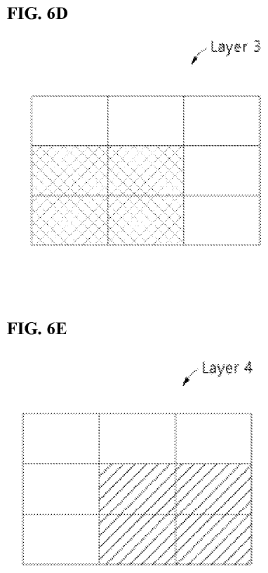

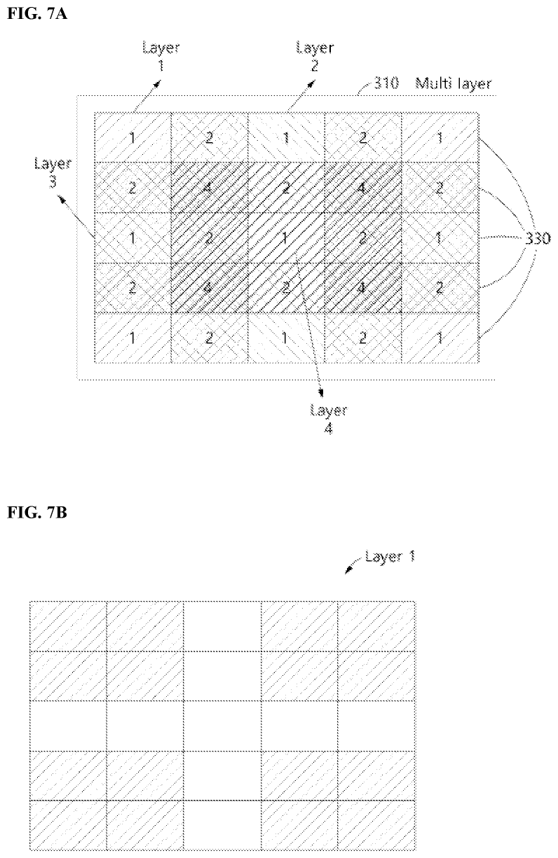

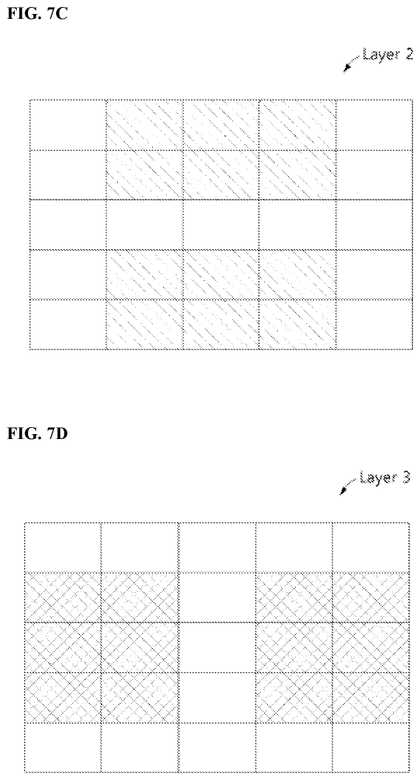

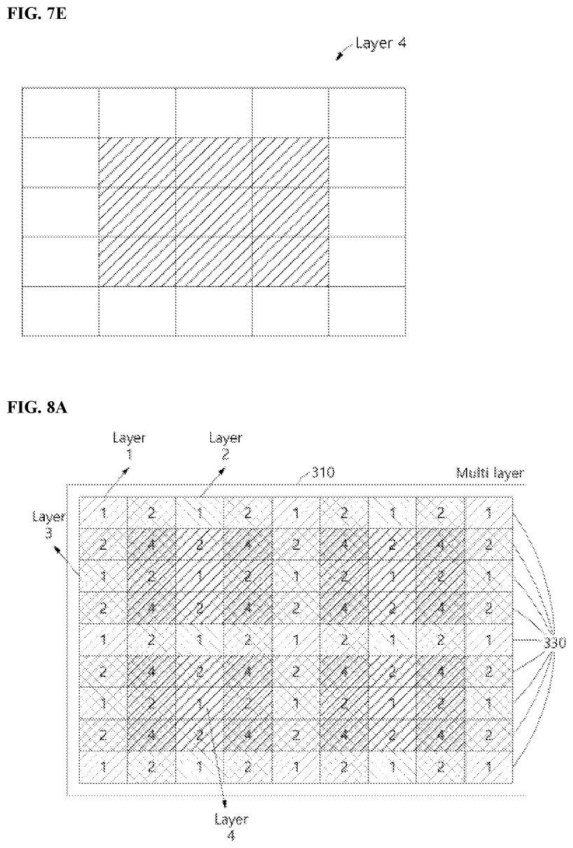

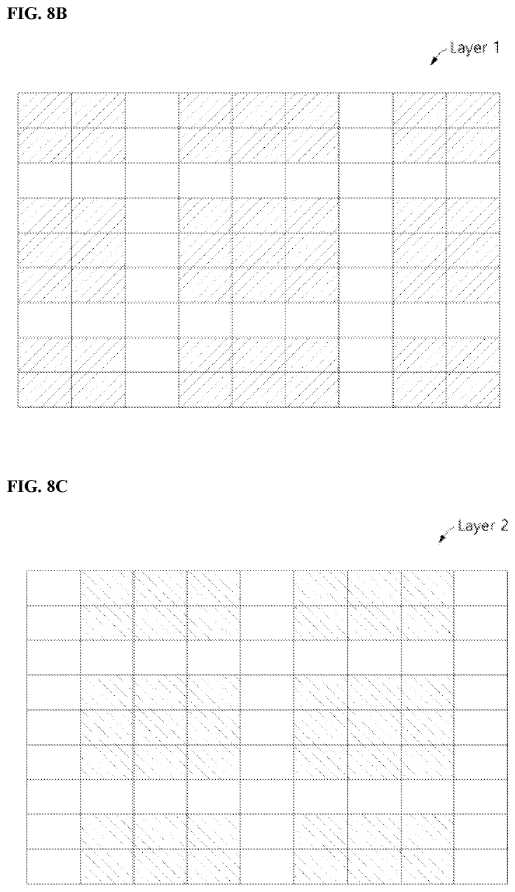

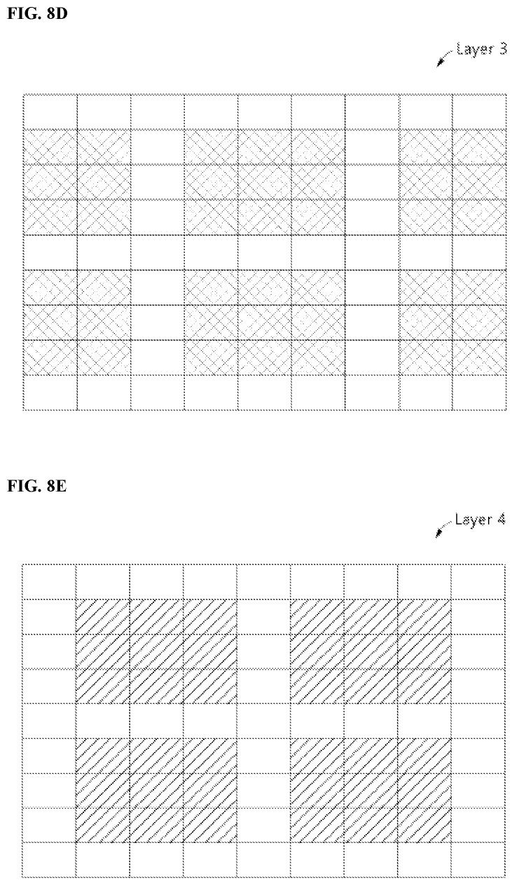

FIG. 5 illustrates an example for describing an overlapping arrangement of readers and/or antennas according to an embodiment, FIG. 5 illustrates an example for describing an overlapping arrangement of readers and/or antennas according to an embodiment, FIG. 6A illustrates another example for describing the overlapping arrangement of the readers and/or antennas according to the embodiment, FIG. 6B illustrates an example for describing readers and/or antennas arranged on a first layer of FIG. 6A, FIG. 6C illustrates an example for describing readers and/or antennas arranged on a second layer of FIG. 6A, FIG. 6D illustrates an example for describing readers and/or antennas arranged on a third layer of FIG. 6A, FIG. 6E illustrates an example for describing readers and/or antennas arranged on a fourth layer of FIG. 6A, FIG. 7A illustrates still another example for describing the overlapping arrangement of the readers and/or antennas according to the embodiment, FIG. 7B illustrates an example for describing readers and/or antennas arranged on a first layer of FIG. 7A, FIG. 7C illustrates an example for describing readers and/or antennas arranged on a second layer of FIG. 7A, FIG. 7D illustrates an example for describing readers and/or antennas arranged on a third layer of FIG. 7A, FIG. 7E illustrates an example for describing readers and/or antennas arranged on a fourth layer of FIG. 7A, FIG. 8A illustrates still yet another example for describing the overlapping arrangement of the readers and/or antennas according to the embodiment, FIG. 8B illustrates an example for describing readers and/or antennas arranged on a first layer of FIG. 8A, FIG. 8C illustrates an example for describing readers and/or antennas arranged on a second layer of FIG. 8A, FIG. 8D illustrates an example for describing readers and/or antennas arranged on a third layer of FIG. 8A, and FIG. 8E illustrates an example for describing readers and/or antennas arranged on a fourth layer of FIG. 8A.

Numbers 1 to 4 illustrated in FIGS. 5, 6A, 7A, and 8A are reader points, and may correspond readers, antenna patterns, or readers+antenna patterns.

Referring to FIG. 5, the substrate 310 may be implemented with four layers (first layer (layer 1) to fourth layer (layer 4)) and include first to fourth sub-substrates corresponding to respective layers.

The reader 330 and the antennas corresponding to the reader 330 may be implemented in a circular shape as illustrated in FIGS. 3 to 4C and may be arranged on the first to fourth sub-substrates by being grouped thereon.

Readers arranged on each layer may overlap some of the readers arranged on an adjacent layer. In this case, antennas corresponding to the readers arranged on each layer may also overlap some of antennas corresponding to the readers arranged on an adjacent layer.

Hereinafter, for convenience of description, an overlapping arrangement of antennas among readers and antennas will be described. The readers may be overlapped and arranged in the same manner as the antennas described below.

For example, regions of the antennas arranged on each layer may include a non-overlapping region (Region 1) that is not overlapping and overlapping regions (Regions 2 to 4) that are overlapping.

The non-overlapping region (Region 1) may be a region in which the tag 100 is recognized through an antenna arranged on any one of the first to fourth sub-substrates. For example, the non-overlapping region (Region 1) is a region in which the position of the tag 100 is read through one antenna and may be a region in which the number of times the tag 100 is recognized is one.

The overlapping regions (Regions 2 to 4) may be composed of Region 2 where two antennas overlap, Region 3 where three antennas overlap, and Region 4 where four antennas overlap.

The overlapping regions (Regions 2 to 4) may be regions for recognizing the tag 100 through antennas arranged on two or more sub-substrates among the first to fourth sub-substrates. For example, Region 2 is a region in which the position of the tag 100 is read through two antennas and may be a region in which the number of times the tag 100 is recognized is two. Region 3 is a region in which the position of the tag 100 is read through three antennas and may be a region in which the number of times the tag 100 is recognized is three. Region 4 is a region in which the position of the tag 100 is read through four antennas and may be a region in which the number of times the tag 100 is recognized is four. Accordingly, the number of times of actual recognitions for the tag 100 may increase in the overlapping regions (Regions 2 to 4) than in the non-overlapping region (Region 1) according to the number of overlapping antennas.

Referring to FIGS. 6A, 7A, and 8A, the antennas may be implemented in various shapes such as a square shape as well as a circular shape.

The antennas arranged to overlap may be arranged on each layer in various patterns depending on the size of a measurement point for measuring (or reading) the position of the tag 100 and the size of the antenna. The size of the measurement point and the size of the antenna may be preset. In this case, the reader 330 may also be arranged on each layer in the same pattern and size as the antenna.

Referring to FIGS. 6B to 6E, when the size of the measurement point is 3×3, the number of measurement points is nine, the size of a single antenna is 2×2, and the number of antennas included in the size of the measurement point is four, the pattern shapes of the antennas arranged on each layer may be formed as illustrated in FIGS. 6B to 6E so that the overlapping region is implemented by Region 2 to Region 4.

Referring to FIGS. 7B to 7E, when the size of the measurement point is 5×5, the number of measurement points is twenty-five, the size of a single antenna is 3×3, and the number of antennas included in the size of the measurement point is nine, the pattern shapes of the antennas arranged on each layer may be formed as illustrated in FIGS. 7B to 7E so that the overlapping region is implemented by Region 2 to Region 4.

Referring to FIGS. 8B to 8E, when the size of the measurement point is 9×9, the number of measurement points is eighty-one, the size of a single antenna is 3×3, and the number of antennas included in the size of the measurement point is twenty-five, the pattern shapes of the antennas arranged on each layer may be formed as illustrated in FIGS. 8B to 8E so that the overlapping region is implemented by Region 2 to Region 4.

As described above, when the antennas are arranged to be overlapped, the same number of measurement points as the number of measurement points when the antennas are not arranged to be overlapped may be formed using a smaller number of antennas than when the antennas are not arranged to be overlapped.

When the antennas are not arranged to be overlapped, a total of eighty-one measurement points can be formed through eighty-one antennas.

However, as described above, when the antennas are arranged to be overlapped as illustrated in FIG. 8A, a total of eighty-one measurement points can be formed through twenty-five antennas.

That is, as described above, when the antennas are arranged to overlap each other in various shapes (and/or various sizes) and in various patterns, the size of the substrate 310 may be reduced compared to when the antennas are not arranged to be overlapped. The number of antennas included in the substrate 310 may be less than the number of antennas when the antennas are not arranged to be overlapped. Accordingly, the position reading (or measurement) of the tag 100 when the antennas are arranged to be overlapped can be performed more accurately, finely, and efficiently with the number of measurement points formed more efficiently when the antennas are not arranged to be overlapped, through fewer antennas than the number of antennas not arranged to be overlapped.

The antenna described above may be implemented in a simple 2D form and a 3D form. For example, the antenna may form a three-dimensional overlapping region even in a 3D space to enable spatial position reading and communication for the tag 100.

As described above, the reader 330 is arranged to be overlapped to correspond to the same shape, size, pattern, and position as the antenna, but is not limited thereto. For example, the reader 330 may not be arranged to be overlapped and be arranged at a position that is distinct from the position of the antenna. In this case, the reader 330 may read the tag 100 through measurement points formed through the antennas arranged to be overlapped.

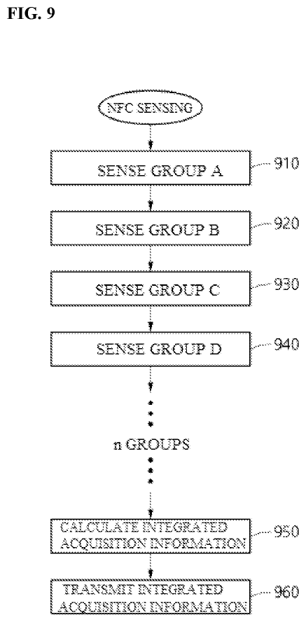

FIG. 9 is a flowchart illustrating an operation of the controller illustrated in FIG. 2.

The controller 370 may switch a plurality of readers, which are grouped for each layer, for each group to recognize information of the tag 100 without interference between the readers.

For example, the controller 370 may sense (or read, acquire, and recognize) tag information detected by Group A by activating the readers of Group A grouped on the first layer of the substrate 310 (910), and sense tag information detected by Group B by activating the readers of Group B grouped on the first layer (920).

The controller 370 may sense the tag information detected by Group C by activating the readers of Group C grouped on the second layer of the substrate 310 (930), and sense tag information sensed by Group D by activating the readers of Group D grouped on the first layer (940).

As described above, the controller 370 may sense tag information detected by all groups by activating the groups (Groups A to N) one by one so that all groups (Groups A to N) for the readers are switched according to the layer order.

The controller 370 may calculate integrated acquisition information by integrating sensing information about the tag 100 sensed through the readers for each layer and for each group (950).

When the tag 100 is positioned on the top of any one reader of the readers of the Group A, the controller 370 may recognize information of the tag 100 when the readers of the Group A is activated. The controller 370 may recognize that that the tag 100 on the top of any one reader of Group A has been detected, after activating all of the readers of Group A to Group N one by one for each group.

The controller 370 may transmit (or transfer) the integrated acquisition information to the electronic device (960).

For example, the electronic device may be various devices such as a personal computer (PC), a data server, or a portable electronic device that process and manage information on the tag 100. The portable electronic devices may be implemented by a laptop computer, mobile phone, smart phone, tablet PC, mobile internet device (MID), personal digital assistant (PDA), enterprise digital assistant (EDA), digital still camera, digital video camera, portable multimedia player (PMP), personal navigation device or portable navigation device (PND), handheld game console, e-book, or a smart device. In this case, the smart device may be implemented by a smart watch or a smart band.

The method according to the embodiment may be implemented in the form of program instructions executable through various computer means and recorded in a computer-readable medium. The computer-readable medium may include program instructions, data files, data structures, etc. alone or in combination. The program instructions recorded on the computer-readable medium may be specially designed and configured for the embodiment or may be known and usable to a person of ordinary skill in computer software. Examples of computer-readable recording media include magnetic media such as hard disks, floppy disks, and magnetic tapes, optical media such as CD-ROMs and DVDs, and magneto-optical media such as floptical disks, and hardware devices specially configured to store and allow program instructions to be executed, such as ROM, RAM, flash memory, etc. Examples of program instructions include not only machine language codes such as those produced by a compiler, but also high-level language codes executable by a computer using an interpreter or the like. The hardware device described above may be configured to operate as one or more software modules to perform the operation of the embodiment, and vice versa.

Software may include a computer program, code, instruction, or a combination of one or more of these, and may configure a processing device to operate as desired or may command the processing device independently or collectively. Software and/or data may be permanently or temporarily embodied in any type of machine, component, physical equipment, virtual equipment, computer storage medium or device, or a transmitted signal wave to be interpreted by the processing device or to provide instructions or data to the processing device. Software may be distributed on computer systems connected via a network and stored or executed in a distributed manner. Software and data may be stored on one or more computer-readable recording media.

Although the embodiments have been described by the limited drawings as described above, a person of ordinary skill in the related art can apply various technical modifications and variations thereto based on the matters above. For example, even if the described techniques are performed in an order different from the described method, and/or components such as systems, structures, devices, circuits, etc. described are coupled or combined in a form different from the described method, or substituted or replaced by other components or equivalents, appropriate results may be achieved.

Therefore, other implementations, other embodiments, and equivalents to claims fall within the scope of the following claims.

What is claimed:

1. A communication apparatus comprising:
a substrate including a plurality of layers; and
a plurality of readers or a plurality of wireless communication antennas that detect a tag and are arranged on at least one of an upper surface and a lower surface of each of the plurality of layers.

2. The apparatus of claim 1, wherein the plurality of readers or the plurality of wireless communication antennas arranged on each of the plurality of layers are arranged by being grouped into a plurality of groups.

3. The apparatus of claim 2, wherein the plurality of readers or the plurality of wireless communication antennas arranged on each of the plurality of layers are grouped based on an arrangement order of readers or a plurality of wireless communication antennas arranged on each layer.

4. The apparatus of claim 1, wherein the plurality of readers or the plurality of wireless communication antennas arranged on each of the plurality of layers are arranged based on positions of readers or a plurality of wireless communication antennas arranged on adjacent layers.

5. The apparatus of claim 4, wherein the plurality of readers or the plurality of wireless communication antennas arranged on each of the plurality of layers are arranged so as not to overlap or overlap the positions of the readers or the plurality of wireless communication antennas arranged on the adjacent layer.

6. The apparatus of claim 1, wherein the plurality of readers or the plurality of wireless communication antennas are arranged so that reading regions for detecting the tag are overlapped or not overlapped with each other.

7. The apparatus of claim 2 further comprising a controller that recognizes tag information by controlling readers or a plurality of wireless communication antennas grouped into any one of the plurality of groups.

8. The apparatus of claim 7, wherein the controller controls activation of the readers or the plurality of wireless communication antennas grouped into any one of the groups.

9. The apparatus of claim 8, wherein the controller controls all of the plurality of readers or the plurality of wireless communication antennas to be switched for each group by activating the readers or the plurality of wireless communication antennas grouped into any one of the groups.

10. A communication system comprising:
a tag; and
a communication apparatus that recognizes information of the tag, wherein the communication apparatus includes a substrate including a plurality of layers and a plurality of readers or a plurality of wireless communication antennas that detects the tag and are arranged on at least one of an upper surface and a lower surface of each of the plurality of layers.

11. The system of claim 10, wherein the plurality of readers or the plurality of wireless communication antennas arranged on each of the plurality of layers are arranged by being grouped into a plurality of groups.

12. The system of claim 11, wherein the plurality of readers or the plurality of wireless communication antennas arranged on each of the plurality of layers are grouped based on an arrangement order of readers or a plurality of wireless communication antennas arranged on each layer.

13. The system of claim 10, wherein the plurality of readers or the plurality of wireless communication antennas arranged on each of the plurality of layers are arranged based on positions of readers or a plurality of wireless communication antennas arranged on adjacent layers.

14. The system of claim 13, wherein the plurality of readers or the plurality of wireless communication antennas arranged on each of the plurality of layers may be arranged so as not to overlap or overlap the positions of the readers or the plurality of wireless communication antennas arranged on the adjacent layer.

15. The system of claim 10, wherein the plurality of readers or the plurality of wireless communication antennas are arranged so that reading regions for detecting the tag are overlapped or not overlapped with each other.

16. The system of claim 11, wherein the communication device further includes a controller that recognizes tag information by controlling readers or a plurality of wireless communication antennas grouped into any one of the plurality of groups.

17. The system of claim 16, wherein the controller controls activation of the readers or the plurality of wireless communication antennas grouped into any one of the groups.

18. The system of claim 17, wherein the controller controls all of the plurality of readers or the plurality of wireless communication antennas to be switched for each group by activating the readers or the plurality of wireless communication antennas grouped into any one of the groups.
